(19) United States
(12) Patent Application Publication
(10) Pub. No.: US 2015/0306782 A1
(43) Pub. Date: Oct. 29, 2015

(54) Chainsaw-type Brush Cutting Assembly

(71) Applicant: Darrell Andrew Joye, Pawleys Island, SC (US)

(72) Inventor: Darrell Andrew Joye, Pawleys Island, SC (US)

(21) Appl. No.: 14/259,323

(22) Filed: Apr. 23, 2014

(51) Int. Cl. B27B 17/08; B27B 17/12; B27B 17/02

(52) U.S. Cl. CPC B27B 17/08; B27B 17/02; B27B 17/12

(57) ABSTRACT

A brush cutting assembly, horizontally oriented and designed to operate in close proximity to the soil surface for clearing brush and other light vegetation, in the form of a plurality of cutting elements pivotally interconnected with one another forming a cutting span propelled by a motor-driven sprocket and wrapped around the peripheral edge of a relatively thin, generally flat member having a marginal edge portion that engages cutting elements along the cutting span which enters the kerf produced by the chainsaw chain during the operation. Said assembly can be applied to substantially any type of tool which uses a drive member commonly used for clearing weeds and light brush, connected by way of a shaft and an arbor. The preferred embodiment being a hand-held type gasoline powered vegetation trimmer.

### BACKGROUND OF THE INVENTION

The invention relates generally to a brush cutting assembly, horizontally oriented and designed to operate in close proximity to the soil surface, for clearing brush and other light vegetation, in the form of a plurality of cutting elements pivotally interconnected with one another forming a cutting span (a “chainsaw chain”, hereinafter) propelled by a motor-driven drive sprocket and wrapped around the peripheral edge of a relatively thin, generally flat member having a marginal edge portion that engages cutting elements along the cutting span which enters the kerf produced by the chainsaw chain during the operation (hereinafter, a “guide bar”). Said assembly can be applied to substantially any type of tool which uses a drive member commonly used for clearing weeds and light brush, connected by way of a shaft and an arbor. The preferred embodiment being a hand-held type gasoline powered vegetation trimmer.

There are innumerous cutting blades and assemblies used in conjunction with hand-held type gasoline powered vegetation trimmers for cutting or clearing undesired vegetation. Examples commonly known to those skilled in the art include U.S. Pat. Nos. 3,708,967 and 4,035,912 and 6,249,978. These assemblies, including the common flail and string type trimmer assemblies of various designs, are only capable of cutting and clearing light herbaceous vegetation and prove ineffective, unsafe and generally unfit for operation in heavier woody vegetation (commonly referred to as “brush”). This invention attempts to provide a safe, effective and economical solution to this long felt need.

### SUMMARY OF INVENTION

Through the years, there have been many attempts to develop a compact, lightweight and inexpensive brush cutting assembly to compliment hand-held type gasoline powered vegetation trimmers, which is both safe and effective to operate. U.S. Pat. Nos. 859,554; 1,988,898; 2,992,664; 3,425,467; 4,627,322; 4,989,489; Swedish Patent No. 80,528; and French Patent No. 1,194,641 each disclose circular rotary saw blade assemblies that employ the use of chainsaw chain cutting members or a chainsaw chain affixed to the periphery of the discs but each fails to accomplish the same work capacity with comparable efficiency and safety as the present invention. A significant deficiency of the saw blade assemblies disclosed in the aforementioned patents is their tendency to occasionally generate negative feedback to the operator in the way of “kick back”. U.S. Pat. No. 4,989,489 defines kick back as a cutting assembly's tendency “to give a sudden, forceful and uncontrolled reaction that caused the blade and supporting elements to move suddenly away from the piece being cut”. Kickback increases the amount of effort required by the operator to maintain proper operation and also increases the probability for operator or bystander injury. There are several other deficiencies which the present invention attempt to overcome. Said deficiencies include but are not limited to the amount of time needed to repair, replace or sharpen cutting members as well as a higher cost of operation. It is the assertion of the inventor that these deficiencies exist due to the need to purchase and replace specialized cutting members specific to their respective embodiments as opposed to the present invention, which makes use of a common chainsaw chain.

U.S. Pat. No. 4,627,322 is most similar to the present invention insomuch as it too discloses a circular rotary saw blade assembly. In this embodiment, the assembly is comprised of two laminated circular discs with a centrally located opening through said laminated discs to receive a drive member to produce rotation. Similar to the present invention, the laminated discs of the aforementioned patent define a chain track around the circumference thereof and a regular chain saw chain is located in the track to create a cutting span. However the method by which the chainsaw chain is anchored or affixed into the chain track is insufficient and may allow for slipping and binding which results in a significant reduction in productivity. Also unlike the present invention, the aforementioned embodiment of U.S. Pat. No. 4,627,322 lacks a chain tensioner adjustment which means that once the chainsaw chain becomes worn or stretched, as is normal wear for a chainsaw chain, the cutting blade becomes inefficient, unsafe and ultimately inoperable. This means the chainsaw chain must be replaced more frequently than that of the present invention which translates to a greater cost of operation.

While many attempts such as those assemblies in the aforementioned patents exhibit an improvement over flail and string type assemblies for the purpose of cutting and clearing brush, it is the assertion of the inventor that the present invention provides a more practical solution for this long felt need. None of the known prior art discloses a brush cutting assembly which makes use of a common chainsaw chain, propelled around a guide bar by a drive gear member, or “drive sprocket”, whose operation is assisted by two forward and lateral facing stabilizers arms. This assembly is designed to increase productivity while reducing vibration, kickback and other negative operator feedback.

### BRIEF DESCRIPTION OF THE DRAWINGS

FIG. 1 is a perspective view of a hand-held type gasoline powered vegetation trimmer to which the preferred embodiment of the invention is attached; and

FIG. 2 is an enlarged downward-peering profile view of the preferred embodiment, this view being exploded; and

FIG. 3 is an exemplary section of the common chainsaw chain that is used in conjunction with the cutting assembly.

The invention will be better understood and additional objects and advantages will become apparent to those skilled in the art from the following description taken in connection with the accompanying drawings.

### DETAILED DESCRIPTION OF A PREFERRED EMBODIMENT

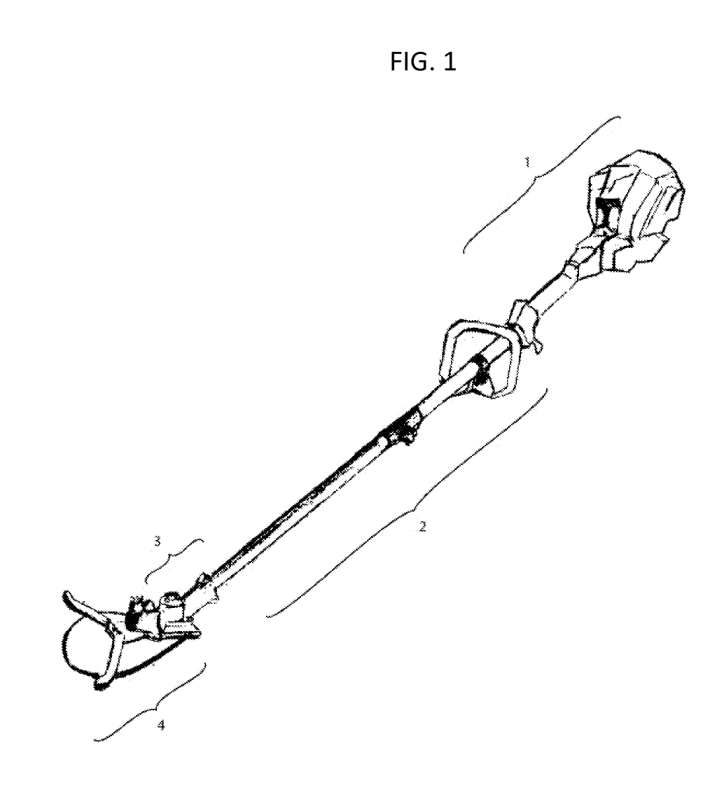

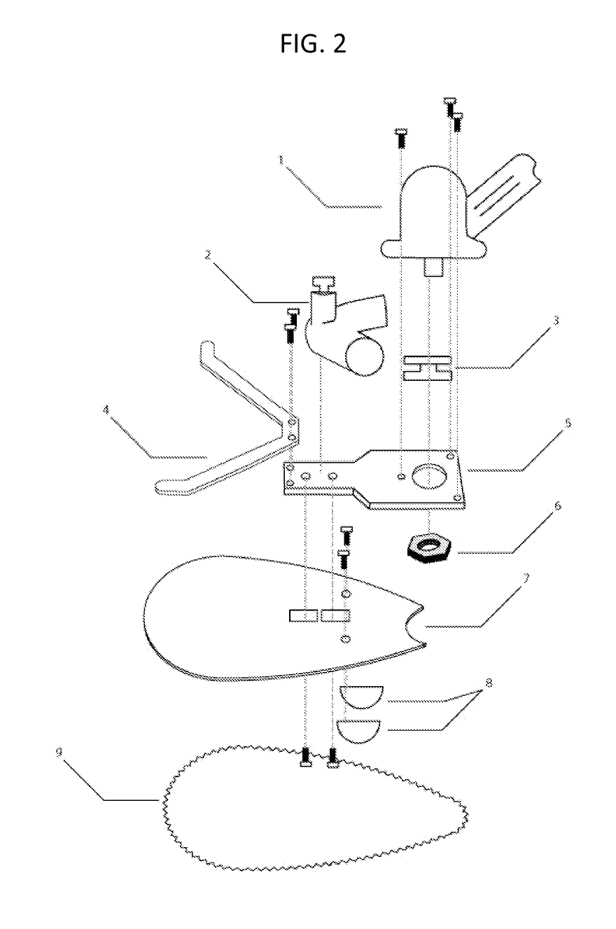

FIG. 1 shows a conventional brush cutting tool with a power head unit (1) and an elongated internal drive shaft means (2) terminating at the bottom in a gear box housing (3) with an output arbor or shaft (out of view). Said brush cutting tool comprising the preferred power tool with which the present invention is applied, either as a permanently affixed cutting assembly or as an interchangeable cutting implement. In the described embodiment, the invention (4) is permanently secured to the conventional brush cutting tool by way of fasteners which attach the assembly chassis (described below and illustrated in FIG. 2) to the gear box housing. Power is transferred from the conventional brush cutting tool and supplied to the cutting assembly by way of a drive sprocket which is fastened to the threaded end of the output arbor using a conventional nut fastener.

Referring now to FIG. 2, and in general terms, the invention is comprised of an assembly chassis (5) to which is affixed an adjustable guide bar (7), a chain lubrication system (2), and stabilizer arms (4). Said assembly is, itself, attached to the gearbox housing (1) of the brush cutting tool. The drive sprocket (3) is nested within said chassis but is not directly attached thereto; rather said drive sprocket is attached to the threaded arbor by way of a fastener nut (6).

The assembly chassis is comprised of a solid piece of a lightweight machined material such as aluminum or carbon fiber and may exist in various shapes and forms in order to adapt to various power sources and manufacturers of said power sources.

The adjustable bar guide, which is attached to the assembly chassis, is constructed in an oval (“tear drop”) shape, with the front end having a broad circumference and tapering to a relatively narrow read end, which provides for a broad cutting span for engaging brush along the leading and side edges of the invention. Said bar guide can be constructed from a single piece of machined lightweight material or from a plurality of laminated sheets of material. The top and bottom planes of the bar guide may be solid or may have cutouts to reduce weight. Regardless of construction and design, the peripheral margin of the bar guide will provide a groove or track in which the depth gauges of the chainsaw chain (described below) travel, forming the cutting span.

The bar guide is further comprised of a two adjustment slots through which threaded fasteners affix the bar guide to the chassis. Said adjustment slots allow the operator to adjust the guide bar away from the drive sprocket in order to increase tension on the chainsaw chain. Conversely, these adjustment slots allow the operator to also bring the bar guide closer to the drive sprocket to reduce tension on the chainsaw chain for easy removal for sharpening and replacement when required. Chain tension adjustment is achieved by slightly loosening the fasteners which affix the bar guide to the assembly chassis and manually sliding the bar within the adjustment slots outward by use of a leverage arm such as a screwdriver placed between the rear end of the bar guide and the drive sprocket; when desired tension is achieved, the fasteners are retightened. It is normal for chainsaw chains to stretch with use; having an adjustable bar guide allows the operator to increase the lifespan of the chainsaw chain by increasing the tension as the chain stretches. Thus making the cost of operation lower than other brush cutting assemblies designed for use with hand-held type gasoline powered vegetation trimmers.

Referring again to FIG. 2, there are two half-sphere floats (8) affixed to the bottom plain of the bar guide. Said spheres may be of various shapes and sizes and constructed from various lightweight materials. These floats allow the operator to simply rest the cutting assembly on the ground while keeping the cutting span itself just above the soil surface. This orientation to the ground helps to reduce operator fatigue, improve performance, and also increase the lifespan of the cutting span by minimizing direct contact with soil which would otherwise quickly dull the cutting elements of the chainsaw chain.

To further reduce operator fatigue and also to improve overall safety and performance, the assembly is further comprised of two forward-facing stabilizer arms, affixed to the upper side of the assembly chassis. Said stabilizer arms extend forward from the leading edge of the assembly chassis (which approximates to the center of the bar guide) at an attitude angle of approximately 45 degrees in either direction from the longitudinal plane of the cutting assembly; at the broadest point of the bar guide, the attitude angle of the left arm (facing forward) becomes 0 degrees from the longitudinal plane and the right arm becomes 90 degrees from the longitudinal plane, or latitudinal. At this point, each arm is positioned outward of the bar guide. Because the chainsaw chain travels in a counter-clockwise direction, the position and attitude of the terminal end of the stabilizer arms allows the operator to essentially wedge stems and trunks of larger brush vegetation between the stabilizer arm and the cutting span while in operation. This helps minimize “kick back” while increasing the efficacy of the cutting span. While there are two individual stabilizer arms, they are in fact constructed of a single piece of bent steel or another lightweight and strong material.

The cutting assembly also provides for a simple lubrication system similar to what is typically found on a conventional chainsaw. In the preferred embodiment of the invention, this system is comprised of a chain lubricant reservoir and a means for dispensing said lubricant. The chain lubricant reservoir is comprised of a port and cap for adding lubricant which is located on the top of the reservoir and also a mechanism for dispensing the lubricant onto the chain near the bottom of the reservoir. In this embodiment, said mechanism is a petcock valve attached to the bottom of the reservoir which is located near the drive sprocket and adjacent the chainsaw chain. By slightly opening the petcock valve prior to operation, lubricant is allowed to drip onto the chain and is evenly and continually distributed along the entirety of the chainsaw chain during operation.

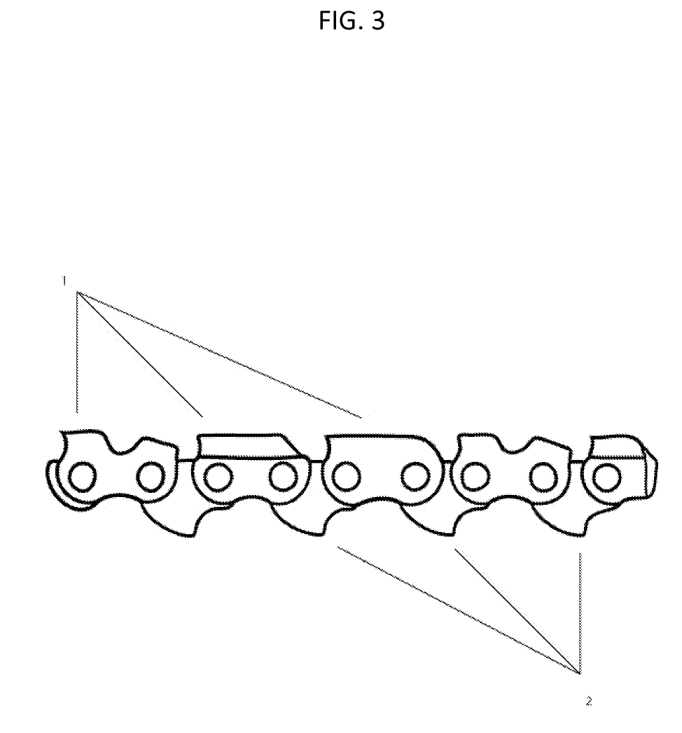

Now referring specifically to FIG. 3, the cutting span of the assembly is comprised of a conventional chainsaw chain having interconnected cutter elements with L-shaped cutting surfaces (1) which enter the kerf produced by the chainsaw chain during the operation and depth gauges, or “tangs” (2) projecting inward into the grooved marginal edge of the adjustable bar guide. Said chainsaw chain (represented as element 9 in FIG. 2) is wrapped in a continual loop around both the drive sprocket and the peripheral edge of the adjustable guide bar and engages both the teeth of the drive sprocket as well as the grooved peripheral edge portion of the adjustable bar guide while in operation.

It is to be understood that the described embodiment of the invention herein shown is to be taken as a preferred embodiment of the same and that variations in the shape, size and arrangement of parts may be resorted to without departing from the spirit of the invention.

That which is claimed:

1. A chainsaw-type brush cutting assembly to be fitted together and secured on a power-driven arbor to be rotated thereby, comprising:
an assembly chassis; and
a flat and relatively thin, horizontally-oriented, guide bar having a front end and a rear end with a shallow groove along the peripheral margin and two half-sphere floats affixed to the bottom plain; and
a horizontally-oriented drive sprocket with an arbor-receiving opening located at its center; and
a chain lubrication system; and
two forward and lateral facing stabilizer arms; and
a cutting span comprised of a plurality of interconnected cutting elements with L-shaped cutting surfaces and depth gauges projecting inward;
wherein said guide bar, said lubrication system, and said stabilizer arms are adjoined by way of said assembly chassis and said drive sprocket is affixed directly to a power-driven, arbor by way of a large hex nut tightly secured to the threaded terminal end of the said arbor.

2. The brush cutting assembly of claim 1 wherein said bar guide has a convex front end with a relatively large circumference and tapering to a concave rear end with a relatively small circumference with a shallow groove along the peripheral edge that engages depth gauges of said cutting span.

3. The brush cutting assembly of claim 1 wherein said bar guide is comprised of two adjustment slots through which threaded fasteners affix the bar guide to said assembly chassis.

4. The brush cutting assembly of claim 1 wherein said stabilizer arms are disposed on the top plain, terminal portion of the front end of said assembly chassis.

5. The brush cutting assembly of claim 1 wherein said lubrication system is disposed on the top plain of said assembly chassis, in a manner that allows for dispensing lubricant directly onto said cutting span.

6. The brush cutting assembly of claim 1 wherein said cutting span is wrapped around the peripheral edge of said guide bar and said drive sprocket to form a continuous cutting span.
